(19) United States
(12) Patent Application Publication
(10) Pub. No.: US 2017/0362927 A1
(43) Pub. Date: Dec. 21, 2017

(54) RANGING TO AN ELECTROMAGNETIC TARGET WITHOUT TIMING

(71) Applicant: Schlumberger Technology Corporation, Sugar Land, TX (US)

(72) Inventors: Andrew G. Brooks, Tomball, TX (US); Luis E. DePavia, Sugar Land, TX (US); Herbert M.J. Illfelder, Houston, TX (US); Jacob Enger, Houston, TX (US)

(21) Appl. No.: 15/533,054

(22) PCT Filed: Dec. 16, 2015
(86) PCT No.: PCT/US2015/065931

§ 371 Date: Jun. 5, 2017

Related U.S. Application Data
(60) Provisional application No. 62/092,320, filed on Dec. 16, 2014.

(51) Int. Cl. E21B 47/022; G01V 3/08; E21B 7/06; G01B 7/004; G01V 3/28; G01V 3/22

(52) U.S. Cl. CPC E21B 47/02224; G01V 3/28; G01V 3/22; E21B 7/06; G01B 7/004; G01V 3/081

(57) ABSTRACT

A method for magnetic ranging includes switching an electromagnet deployed in a target wellbore between at least first and second states and acquiring a plurality of magnetic field measurements at a magnetic field sensor deployed on a drill string in a drilling wellbore while the electromagnet is switching. The magnetic field measurements may be sorted into at least first and second sets corresponding to the first and second states of the electromagnet. The first and second sets of magnetic field measurements are then processed to compute at least one of a distance and a direction from the drilling well to the target. The electromagnet may be automatically switched back and forth between the first and second states independently from the acquiring and sorting of the magnetic field measurements.

### CROSS REFERENCE TO RELATED APPLICATIONS

The present application claims the benefit of, and priority to, U.S. Provisional Patent Application No. 62/092320, filed Dec. 16, 2014, which is hereby incorporated by reference in its entirety.

### FIELD OF THE DISCLOSURE

Disclosed embodiments relate generally to drilling and surveying subterranean boreholes such as for use in oil and natural gas exploration and more particularly to methods for making magnetic ranging measurements to an electromagnetic target without any synchronization between the ranging measurements and the electromagnetic target.

### BACKGROUND INFORMATION

Magnetic ranging techniques are commonly utilized in subterranean well drilling applications. For example, there is commonly a need to determine the location of a drilling well with respect to an existing well (e.g., in well twinning applications and relief well applications). This is sometimes accomplished by deploying an electromagnetic target in one well (e.g., the existing well) and measuring the corresponding magnetic fields received by a sensor package in the other well (e.g., the drilling well).

The use of electromagnets (as the magnetic source) in downhole ranging operations has been known for many years. For example, U.S. Pat. No. 3,406,766 (issued in 1968) discloses a well intercept operation in which a magnetic field is established using a downhole electromagnet. Directional drilling is then guided based on measurements of the magnetic field. U.S. Pat. No. 5,485,089 discloses a well twinning operation in which a high strength electromagnet is pulled down through a cased target well during drilling of a twin well. A magnetic field sensor deployed in the drill string measures the magnitude and direction of the magnetic field during drilling of the twin well to determine a distance and direction to the target.

When using a DC electromagnet, multiple measurements are commonly made at different source excitation states. Errors may arise if the magnetic sensors or the electromagnet move between acquisitions corresponding to different excitation states or if the data acquisition times are not correctly synchronized with respect to the excitation states. U.S. Pat. No. 5,923,170 discloses one such method in which the magnetic field sensors in a drilling well are synchronized with a DC electromagnet in an existing well. This and other such techniques can be prone to synchronization errors which may result in gross ranging errors and significant lost time required to reestablish proper synchronization. Therefore, a need remains for improved magnetic ranging methodologies.

### SUMMARY

A method for magnetic ranging comprising is disclosed. The method includes switching an electromagnet deployed in a target wellbore between at least first and second states and acquiring a plurality of magnetic field measurements at a magnetic field sensor deployed on a drill string in a drilling wellbore while the electromagnet is switching. The magnetic field measurements may be sorted into at least first and second sets corresponding to the first and second states of the electromagnet. The first and second sets of magnetic field measurements are then processed to compute at least one of a distance and a direction from the drilling well to the target. The electromagnet may be automatically switched back and forth between the first and second states independently from the acquiring and sorting of the magnetic field measurements.

The disclosed embodiments may enable the implementation of continuous ranging measurements since the magnetic source (e.g., the solenoid) may continuously transmit and switch states without any need for synchronization with the magnetic field measurements. Moreover, the elimination of timing and synchronization in the start and termination of solenoid activation simplifies magnetic ranging operations and tends to increase accuracy and reliability by eliminating the dependency that exists between the solenoid excitation firing timing and magnetic field acquisition timing.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts one example of a conventional drilling rig on which disclosed methods may be utilized.

FIG. 2 depicts a lower BHA portion of the drill string shown on FIG. 1.

FIG. 3 depicts a flow chart of one disclosed method embodiment.

FIG. 4A depicts one example of a solenoid switching pattern and is a plot of normalized electrical current versus time.

FIG. 4B depicts a plot of normalized magnetic field versus time corresponding to the switching pattern shown on FIG. 4A.

FIG. 5A depicts normalized magnetic field versus percentile for the magnetic field measurements depicted on FIG. 4B.

FIG. 5B depicts a histogram plotting frequency of occurrence versus normalized magnetic field value for the magnetic field measurements depicted on FIG. 4B.

### DETAILED DESCRIPTION

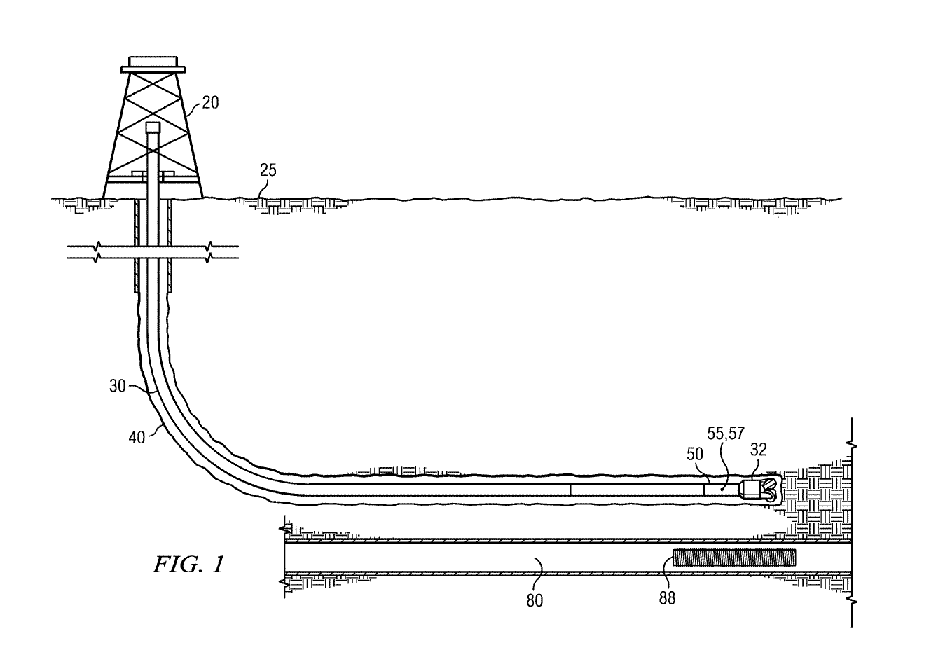

FIG. 1 depicts a drilling rig 20 suitable for using various method embodiments disclosed herein. The rig may be positioned over an oil or gas formation (not shown) disposed below the surface of the Earth 25. The rig 20 may include a derrick and a hoisting apparatus (not shown) for raising and lowering a drill string 30, which, as shown, extends into wellbore 40 and includes a drill bit 32 and a near-bit sensor sub 50 (such as the iPZIG® tool available from PathFinder®, A Schlumberger Company, Katy, Tex., USA). Drill string 30 may further include a downhole drilling motor, a steering tool such as a rotary steerable tool, a downhole telemetry system, and one or more MWD or LWD tools including various sensors for sensing downhole characteristics of the borehole and the surrounding formation. The disclosed embodiments are not limited in these regards.

FIG. 1 further depicts a well twinning operation, such as a steam assisted gravity drainage (SAGD) operation, in which various disclosed method embodiments may be utilized. Common SAGD well twinning operations require a horizontal twin well 40 to be drilled a substantially fixed distance above a horizontal portion of a target wellbore 80 (e.g., not deviating more than about 1 meter up or down or to the left or right of the target). In the depicted embodiment the target well 80 is drilled first, for example, using conventional directional drilling and MWD techniques. The target wellbore 80 may be magnetized, for example, via deploying a magnetic source 88 such as a DC electromagnet in the wellbore 80. Magnetic field measurements made in sensor sub 50 may then be used to determine a relative distance and direction from the drilling well 40 to the target well 30 (as described in more detail below).

It will be understood by those of ordinary skill in the art that the deployment illustrated on FIG. 1 is merely an example. For example, while FIG. 1 depicts a SAGD operation, the disclosed embodiments are in no way limited to SAGD or other well twinning operations, but may be used in substantially any drilling operation in which it is desirable to determine the relative location of the drilling well with respect to an offset (or target) well. Moreover, while FIG. 1 depicts a near-bit sensor sub 50, it will be understood that the disclosed embodiments are not limited to the use of a near-bit sensor sub or to the deployment of the sensor sub close to the bit (although deployments close to the bit 32 may be desirable). The disclosed embodiments may be performed onshore (as depicted) or offshore.

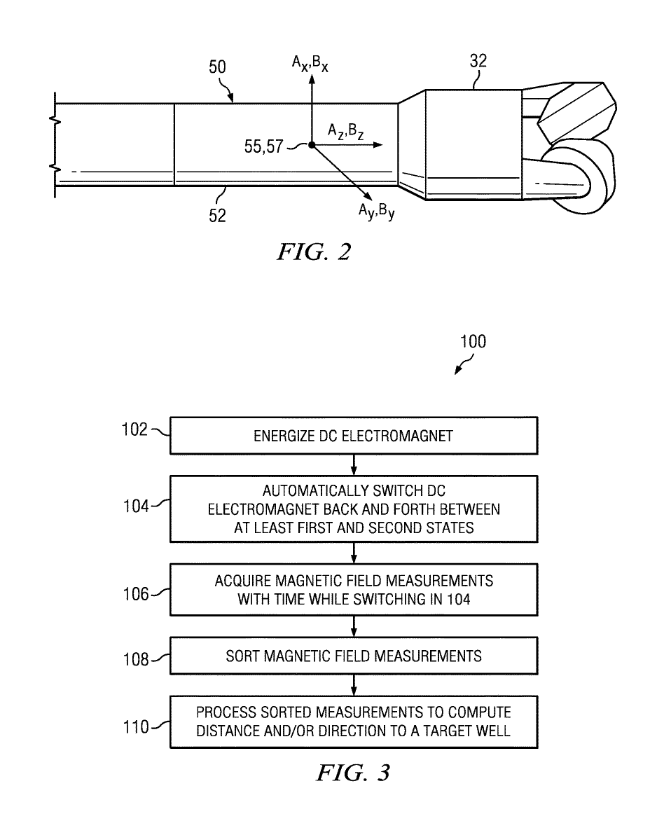

FIG. 2 depicts the lower BHA portion of drill string 30 including drill bit 32 and sensor sub 50. In the depicted embodiment, sensor sub body 52 is threadably connected with the drill bit 32 and therefore configured to rotate with the bit 32 (although the disclosed embodiments are not limited in this regard as the sensors may be deployed on a substantially non-rotating housing). The depicted sensor sub 50 includes a tri-axial (three axis) accelerometer set 55 and a tri-axial magnetometer set 57. Substantially any suitable measurement tool (such as a conventional MWD tool) including a magnetic field sensor may be utilized. Suitable accelerometers and magnetometers for use in sensors 55 and 57 may be chosen from among substantially any suitable commercially available devices known in the art.

FIG. 2 further includes a diagrammatic representation of the tri-axial accelerometer and tri-axial magnetometer sensor sets 55 and 57. By tri-axial it is meant that each sensor set includes three mutually perpendicular sensors, the accelerometers being designated as Aₓ, A_{y}, and A_{z}, and the magnetometers being designated as Bₓ, B_{y}, and B_{z}. By convention, a right handed system is designated in which the z-axis accelerometer and magnetometer (A_{z}, and B_{z}) are oriented substantially parallel with the borehole as indicated (although disclosed embodiments are not limited by such conventions). Each of the accelerometer and magnetometer sets may therefore be considered as determining a transverse cross-axial plane (the x and y-axes) and an axial pole (the z-axis along the axis of the BHA). By further convention, the gravitational field is taken to be positive pointing downward (i.e., toward the center of the Earth) while the magnetic field is taken to be positive pointing towards magnetic north.

It will be understood that the disclosed embodiments are not limited to the above described conventions for defining the borehole coordinate system. Nor are the disclosed embodiments limited to the use of tri-axial accelerometer and tri-axial magnetometer sensor sets as depicted on FIG. 2.

FIG. 3 depicts a flow chart of one disclosed method embodiment 100. Method 100 makes use of a system such as depicted on FIG. 1 in which a DC electromagnet is deployed in one well and magnetic field sensors are deployed in the other. The DC electromagnet is energized at 102. The polarization state of the DC electromagnet is automatically switched between at least first and second states at 104 (e.g., back and forth between positive and negative polarities). Magnetic field measurements are acquired at a predetermined interval at 106 while switching at 104. The acquired magnetic field measurements are sorted according to predefined criteria at 108 (e.g., via clustering). The sorted measurements may then be processed at 110 to compute the distance and/or the direction from the drilling well to the target well (or equivalently from the target well to the drilling well).

The DC electromagnet may be deployed in the target well using substantially any conventional means. For example, the DC electromagnet may be pushed down the target well using coiled tubing or drill pipe conveyance. The DC electromagnet may alternatively be pulled along a horizontal section of the target wellbore using a downhole tractor. Electrical current may be supplied from the surface using wireline or slick line conductors.

The DC electromagnet may include a solenoid configured to switch between first and second states, for example, positive and negative states according to the direction of flow of the energizing electrical current. The switching between states is configured to occur automatically without intervention of an operator and independent of the measurement and sorting of the magnetic field measurements at 106 and 108. For example, a surface controller may be configured to switch the solenoid back and forth between first and second states every few seconds. The switching may alternatively be manually controlled. In such manual embodiments, the switching is independent of the measurement and sorting at 106 and 108.

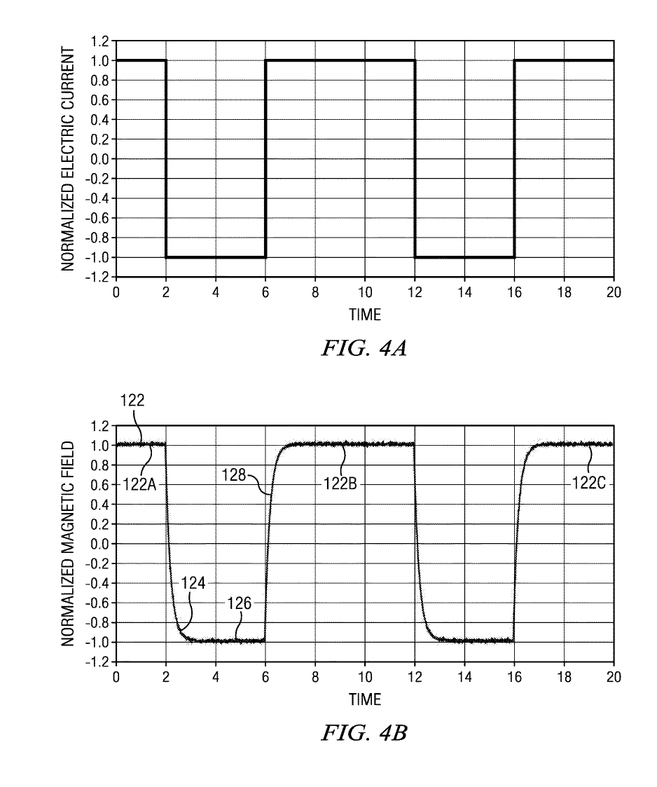

FIG. 4A depicts one example of a solenoid switching pattern and is a plot of normalized electrical current versus time. As depicted, the electrical current switches from positive to negative at a time of two seconds, then from negative back to positive at a time of six seconds and so on (switching again at 12 and 16 seconds). It will be understood that the switching pattern is not necessarily periodic or repetitive. In the depicted embodiment, the switching pattern is asymmetric in that the electrical current remains positive for six seconds while remaining negative for only four seconds. This feature is described in more detail below.

It will be understood that the disclosed embodiments are not limited to switching between merely first and second solenoid states. In alternative embodiments, a solenoid may be switched back and forth between substantially any number of states, for example, including first, second, and third states such as positively directed current, negatively directed current, and off (no current) or between first, second, third, and fourth states including two distinct positive levels and two distinct negative levels. The above described techniques for sorting the magnetic field measurements apply equally well to embodiments employing two, three, four, or more solenoid states.

FIG. 4B depicts a corresponding plot of normalized total magnetic field (TMF) versus time. The magnetic field measurements may be obtained using tri-axial magnetometers deployed in a downhole tool (such as magnetometers 57 in sensor sub 50 on FIGS. 1 and 2). The magnetic field measurements may be made substantially continuously at a time interval significantly less than the switching interval. For example, magnetic field measurements may be made at approximately 10 millisecond intervals while switching the solenoid back and forth between the first and second states shown on FIG. 4A (although the disclosed embodiments are not limited in this regard).

In FIG. 4B the measured magnetic field is approximately constant at a normalized value of 1.0 (as shown at 122) when the solenoid is in the first state. When the solenoid is switched to the second state at a time of two seconds, the magnetic field rapidly changes (as shown at 124) from a normalized value of 1.0 to a normalized value of −1.0 (as shown at 126). In general, the transition occurs rapidly, e.g., within a few tenths of a second, and may be related to the magnetic properties of the casing string in the target well among other factors. At six seconds, the magnetic field rapidly changes (as shown at 128) from a normalized value of −1.0 back to a normalized value of 1.0, and so on (transitioning again at 12 and 16 seconds). It will be understood that the magnetic field measurements need not be synchronized with the switching and that a measurement cycle does not necessarily begin or end simultaneously with a switching event.

With continued reference to FIG. 4B, the data acquisition rate (the time interval between sequential magnetic field measurements) is generally fast with respect to the times of stable excitation (shown at 122 and 124) and may also be fast with respect to the transition times (shown at 126 and 128). For example, the data acquisition rate may be on the order of about 10 milliseconds, while the stable excitation times may be on the order of a few seconds and the transition times may be on the order of a few tenths of seconds. Moreover, the magnetic field measurements may be accumulated over a length of time that includes at least one instance of each of the states with the time of total acquisition preferably being equal to an integer number of full cycles (although the disclosed embodiments are not limited in this regard).

The measured magnetic field data (e.g., as depicted on FIG. 4B) may be sorted, for example, according to the measured magnetic field values (the normalized values shown on FIG. 4B). In general, the magnetic field data may be classified via clustering. For example, in a case in which two stable excitation states are utilized (e.g., positive and negative), the data points may be classified as belonging to one of two clusters or to being an outlier. A second level of clustering may involve grouping data that are temporally connected within one of the previous clusters. For example, the data at 122A, 122B, and 122C in FIG. 4B may be clustered into separate (but related) groups.

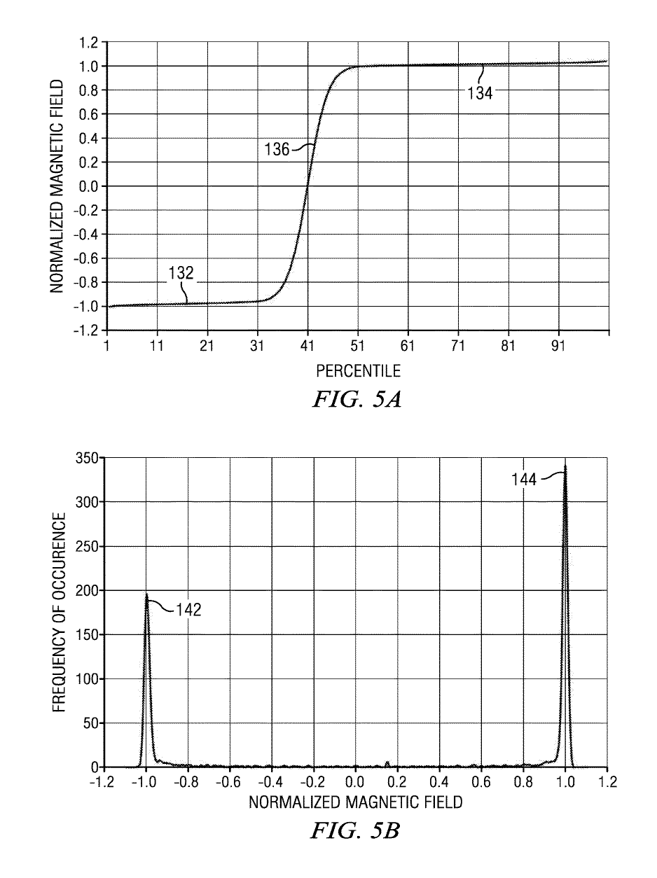

FIG. 5A depicts a plot of normalized magnetic field values versus percentile in which the data may be separated into a plurality of groups such as percentiles. In the depicted example the acquisition interval is 20 seconds (see FIGS. 4A and 4B) and the magnetic field measurement rate is 100 measurements per second (an interval of 10 milliseconds) resulting in 2000 total measurements. In FIG. 5A the measured data are sorted according to their TMF values and split into 100 groups (percentiles), each containing 20 similar measurements. It will be understood that in this example measurements from multiple sensors may be combined to compute the TMF prior to sorting. The disclosed embodiments are not limited in this regard as described in more detail below.

As depicted on FIG. 5A, the magnetic field measurements are distributed primarily among two clusters of values (indicated at 132 and 134) corresponding to the average values associated with the first and second solenoid states. Adjoining groups (individual percentiles) tend to have similar values within these two clusters. Intermediate values (indicated at 136) may correspond to the transitions between the first and second solenoid states. Corresponding magnetic field values may be assigned to the first and second clusters (and therefore the first and second solenoid states) by averaging a number of the first percentiles to obtain a first magnetic field value corresponding with the first solenoid state and by averaging a number of the last percentiles to obtain a second magnetic field value corresponding with the second solenoid state. For example, values may be extracted from the data shown on FIG. 5A by noting that there are 40 percentiles before the midrange and 60 percentiles after. The first 20 percentiles may then be averaged to obtain the first magnetic field value in the last 30 percentiles may be averaged to obtain a second magnetic field value. As described in more detail below a measurement value may be taken to be the difference between the first and second magnetic field values, representing the difference between measurement values corresponding to the first and second solenoid states.

FIG. 5B depicts a histogram plotting frequency of occurrence versus normalized magnetic field value for the magnetic field measurements depicted on FIG. 4B. The first and second clusters of magnetic field values are evident in the histogram at 142 and 144. The magnetic field value at each peak may be considered to represent the magnetic field values at the corresponding first and second solenoid states.

Magnetic ranging applications commonly require the use of a magnetic field sensor having multiple magnetometer channels (e.g., three magnetic channels arranged as a set of three orthogonal sensors as depicted on FIG. 2). In order to avoid ambiguity in the direction of the magnetic vector it may be necessary to determine the sign (positive or negative) of each of the magnetometer measurements. One way to accomplish this is to use asymmetric switching of the solenoids as depicted on FIG. 4A. By asymmetric it is meant that the durations of the first and second solenoid states are different (in the example depicted on FIG. 4A the duration of the first state is six seconds while the duration of the second state is four seconds). In this way, each of the data clusters will include a different number of data points thereby allowing each of the clusters, corresponding to be positive and negative solenoid states, to be identified. For example, in FIGS. 5A and 5B, the data cluster corresponding to the first solenoid state includes 60 percentiles and has a larger peak as compared to the data cluster corresponding to the second solenoid state which includes 40 percentiles and has a smaller peak. The above described second level clustering may also optionally be employed to identify the asymmetric switching, for example, via counting the number of measurements in each of the second level clusters.

It will be understood that magnetic field measurements made using multiple magnetic field sensors may be clustered (sorted) together (e.g., as in the above depicted TMF examples) or separately. As is known to those of ordinary skill in the art, a commonly utilized magnetic field sensor set includes three mutually orthogonal sensors, e.g., defining x-, y-, and z- axes. The magnetic field measurements made using each of these sensors may be separately sorted to obtain, for example, clustered x-axis, clustered y-axis, and clustered z-axis magnetic field measurements. These separately clustered measurements may then be processed, e.g., to obtain a magnitude and direction of a measured magnetic field vector.

With reference again to FIG. 3, the sorted measurements may be processed at 110 using substantially any suitable magnetic ranging processing techniques to compute the distance and/or the direction from the drilling well to the target well. The sorted measurements may be processed, for example, to compute a target magnetic field (e.g., the magnetic field emanating from the solenoid). The target magnetic field may be found, for example, by computing a difference between the measured magnetic field vectors acquired in the first and second states (e.g., when there is positively and negatively directed current in the solenoid). Taking such a difference causes the Earth's magnetic field (and any other constant interference field) to be canceled leaving essentially only the target field. The three components of the target magnetic field vector (e.g., obtained from the above described three mutually orthogonal magnetic field sensors in the tri-axial magnetometer set) may be combined to obtain a target magnetic field vector or axial and cross-axial components of the target magnetic field using techniques known to those of ordinary skill in the art.

The target magnetic field vector (e.g., the axial and cross-axial components) may be resolved into a range and bearing (distance and direction) to the target, for example, by inversion of models or maps of the field around the target (or using a look-up table or an empirical algorithm based on the model). Such inversion may be performed graphically (e.g., using graphical solvers) or numerically (e.g., using sequential one dimensional solvers). The disclosed embodiments are not limited in this regard. Various ranging methodologies are described in more detail in commonly assigned U.S. Pat. Nos. 7,617,049 and 7,656,161 and U.S. Patent Publications 2012/0139530 and 2012/0139545 (each of which is fully incorporated by reference herein).

These models or maps of the magnetic field may be empirical or theoretically based. For example, the solenoid may be modeled as a magnetic dipole having a predetermined pole strength. Moreover, the magnetic field about a wellbore in which an electromagnetic source is deployed and energized may be modeled, for example, using conventional finite element techniques. Empirical maps may also be generated at the Earth's surface, e.g., by making tri-axial magnetic field measurements at various locations about an energized solenoid. In certain embodiments, the use of empirical models (or blended models in which a theoretic model is modified using empirical data) may be advantageous, for example, when the solenoid is deployed in a cased wellbore. Such an empirical map (model) may be generated by deploying the energized solenoid in a length of casing string supported (e.g., horizontally) above the surface of the earth. Tri-axial magnetic field measurements may be made at various locations on a two-dimensional matrix (grid) of known orthogonal distances and normalized axial positions relative to the electromagnet to generate the magnetic field map. Known interpolation and extrapolation techniques may then be used to determine the magnetic field vectors at substantially any location relative to array.

Those of ordinary skill in the art will readily recognize that any vector (e.g., magnetic field vector) may be analogously defined by either (i) the magnitudes of first and second in-plane, orthogonal components of the vector or by (ii) a magnitude and a direction (angle) relative to some in-plane reference. Likewise, the target magnetic field measured as described above may be defined by either (i) the magnitudes of first and second in-plane, orthogonal components or by (ii) a magnitude and a direction (angle). A suitable magnetic field model (or map) may also be expressed in terms of the magnitudes of first and second in-plane, orthogonal components of the vector or in terms of a magnitude and a direction (angle) of the magnetic field vector.

The target magnetic field vector measured as described above may further be utilized to compute a direction from the magnetic field sensors (e.g., located in the drilling well) to the electromagnet (e.g., located in the target well). The direction may be referenced, for example, to magnetic north or true north). The direction may be obtained, for example, by transposing the computed interference magnetic field vector to a plan view (i.e., a horizontal view). Those of ordinary skill in the art will readily appreciate that the azimuth angle of the transposed interference magnetic field vector is equivalent to the direction from the sensors to the electromagnet.

The above described methodology may further include repositioning the magnetic field sensor at one or more other geometric positions relative to the electromagnet (e.g., by continuing to drill the drilling well) and then repeating steps 104 to 108 so as to obtain additional ranging measurements. These multiple ranging measurements may be used to guide drilling of the drilling well towards the target well (or in a particular direction with respect to the target well).

A plurality of magnetic field measurements made at a corresponding plurality of relative positions (as described in the preceding paragraph) also enables the relative position between the two wells to be determined using other methods. For example, the acquisition of multiple magnetic field measurements enables conventional two-dimensional and three-dimensional triangulation techniques to be utilized. U.S. Pat. No. 6,985,814 discloses a triangulation technique utilized in passive ranging operations.

It will be understood that while not shown in FIGS. 1 and 2, downhole measurement tools suitable for use with the disclosed embodiments generally include at least one electronic controller. Such a controller typically includes signal processing circuitry including a digital processor (a microprocessor), an analog to digital converter, and processor readable memory. The controller typically also includes processor-readable or computer-readable program code embodying logic, including instructions for obtaining and sorting magnetic field measurements, for example, as described above with respect to FIGS. 3-5.

A suitable controller typically includes a timer including, for example, an incrementing counter, a decrementing time-out counter, or a real-time clock. The controller may further include multiple data storage devices, various sensors, other controllable components, a power supply, and the like. The controller may also optionally communicate with other instruments in the drill string, such as telemetry systems that communicate with the surface or an EM (electro-magnetic) shorthop that enables the two-way communication across a downhole motor. It will be appreciated that the controller is not necessarily located in the sensor sub (e.g., sub 50), but may be disposed elsewhere in the drill string in electronic communication therewith. Moreover, one skilled in the art will readily recognize that the multiple functions described above may be distributed among a number of electronic devices (controllers).

Although ranging to an electromagnetic target without timing and certain advantages thereof have been described in detail, it should be understood that various changes, substitutions and alternations can be made herein without departing from the spirit and scope of the disclosure as defined by the appended claims.

What is claimed is:

1. A method for magnetic ranging comprising:
(a) switching an electromagnet deployed in a target wellbore between at least first and second states;
(b) acquiring a plurality of magnetic field measurements at a magnetic field sensor deployed on a drill string in a drilling wellbore while the electromagnet is switching in (a);
(c) sorting the plurality of magnetic field measurements into at least first and second sets corresponding to the first and second states of the electromagnet;
(d) processing the first and second sets of magnetic field measurements to compute at least one of a distance and a direction from the drilling well to the target.

2. The method of claim 1, wherein the electromagnetic automatically switches back and forth between the at least first and second states in (a) and said switching is independent from said acquiring in (b) and said sorting in (c).

3. The method of claim 2, wherein the switching in (a) is asymmetric in that the electromagnet is in the first state for a longer time duration than the second state.

4. The method of claim 1, wherein the electromagnet is energized by a positively directed direct current in the first state and a negatively directed direct current in the second state.

5. The method of claim 1, wherein the plurality of magnetic field measurements are acquired in (b) at a time interval less than a time interval of the switching in (a) and less than a time interval of a transition between the first and second states.

6. The method of claim 1, wherein the plurality of magnetic field measurements are sorted in (c) according to measured magnetic field values.

7. The method of claim 6, wherein the magnetic field values are sorted into a plurality of groups, the first set being assigned a value equal to an average of a first plurality of the groups and the second set being assigned a value equal to an average of a second plurality of the groups.

8. The method of claim 6, wherein the first set is assigned a value equal to a magnetic field value at a first peak in a histogram and the second set is assigned a value equal to a magnetic field value at a second peak in the histogram.

9. The method of claim 1, wherein the plurality of magnetic field measurements acquired in (b) comprises a corresponding plurality of x-axis magnetic field measurements, a corresponding plurality of y-axis magnetic field measurements, and a corresponding plurality of z-axis magnetic field measurements.

10. The method of claim 9, wherein said sorting in (c) comprises:
sorting the plurality of x-axis magnetic field measurements into at least first and second sets of x-axis measurements corresponding to the first and second states of the electromagnet;
sorting the plurality of y-axis magnetic field measurements into at least first and second sets of y-axis measurements corresponding to the first and second states of the electromagnet; and
sorting the plurality of z-axis magnetic field measurements into at least first and second sets of z-axis measurements corresponding to the first and second states of the electromagnet.

11. The method of claim 1, wherein the processing in (d) comprises:
(i) computing a difference between the first and second sets of magnetic field measurements; and
(ii) processing the difference to compute at least one of a distance and a direction from the drilling well to the target.

12. The method of claim 11, wherein the difference comprises a difference between a magnetic field vector measured in the first state and a magnetic field vector measured in the second state.

13. The method of claim 11, wherein the difference is processed in combination with a map or model of a magnetic field about the target wellbore.

14. The method of claim 1, further comprising:
(e) moving the magnetic field sensors to another location in the wellbore; and
(f) repeating (b), (c), and (d).

15. A method for magnetic ranging comprising:
(a) automatically switching an electromagnet deployed in a target wellbore back and forth between at least first and second states;
(b) acquiring a plurality of x-axis, y-axis, and z-axis magnetic field measurements using a tri-axial magnetic field sensor deployed on a drill string in a drilling wellbore while the electromagnet is automatically switching in (a);
(c) sorting the plurality of x-axis magnetic field measurements into at least first and second sets of x-axis measurements corresponding to the first and second states of the electromagnet;
(d) sorting the plurality of y-axis magnetic field measurements into at least first and second sets of y-axis measurements corresponding to the first and second states of the electromagnet;
(e) sorting the plurality of z-axis magnetic field measurements into at least first and second sets of z-axis measurements corresponding to the first and second states of the electromagnet; and
processing the first and second sets of x-axis, y-axis, and z-axis magnetic field measurements to compute at least one of a distance and a direction from the drilling well to the target.

16. The method of claim 15, wherein said automatic switching in (a) is independent from said acquiring in (b) and said sorting (c), (d), and (e).

17. The method of claim 15, wherein the switching in (a) is asymmetric in that the electromagnet is in the first state for a longer time duration than the second state.

18. The method of claim 15, wherein the processing in (f) comprises computing a difference between a magnetic field vector measured in the first state and a magnetic field vector measured in the second state.

19. The method of claim 18, wherein the difference is processed in combination with a map or model of a magnetic field about the target wellbore to compute the distance and the direction.
